(19) United States
(12) Patent Application Publication
(10) Pub. No.: US 2020/0310409 A1
(43) Pub. Date: Oct. 1, 2020

(54) COMMUNICATION APPARATUS, COMMUNICATION METHOD, AND STORAGE MEDIUM

(71) Applicant: HONDA MOTOR CO., LTD., Tokyo (JP)

(72) Inventors: Masaru OTAKA, Wako-shi (JP); Toshiaki TAKANO, Tokyo (JP)

(21) Appl. No.: 16/826,576

(22) Filed: Mar. 23, 2020

(30) Foreign Application Priority Data
Mar. 29, 2019 (JP) 2019-067123

(51) Int. Cl. G05D 1/00; G08G 1/01; G05D 1/02

(52) U.S. Cl. CPC G05D 1/0016; G05D 1/0246; G08G 1/0116

(57) ABSTRACT

A communication apparatus that acquires information used for controlling a mobile body is provided. The apparatus includes a specifying unit configured to specify one or more other communication apparatuses with which the communication apparatus is to communicate, based on a geographical location of the mobile body, and an acquisition unit configured to acquire information from the one or more other communication apparatuses that have been specified.

### CROSS-REFERENCE TO RELATED APPLICATION(S)

This application claims priority to and the benefit of Japanese Patent Application No. 2019-067123 filed on Mar. 29, 2019, the entire disclosure of which is incorporated herein by reference.

### BACKGROUND OF THE INVENTION

### Field of the Invention

The present invention relates to a communication apparatus, a communication method, and a storage medium.

### Description of the Related Art

Remote driving techniques, also known as tele-operated driving techniques, in which a vehicle is operated by an operator located in a distant place are known. There is a demand for, in remote driving, sufficiently suppressing a delay in communication between an operator apparatus for an operator that executes remote driving and a user terminal mounted in a vehicle, along with other demands. In Japanese Patent Laid-Open No. 2013-115803, a communication amount is reduced by transmitting difference information of three-dimensional map data of the environment around a vehicle.

### SUMMARY OF THE INVENTION

A control apparatus of a vehicle controls the vehicle using traffic information from various apparatuses such as a road management camera that shoots an image of a road. It is expected to reduce a communication amount in acquisition of this traffic information as well. The need for reducing a communication amount is the same whether a control apparatus of a vehicle is mounted in the vehicle or is outside the vehicle, and even in a case of a mobile body that is not a vehicle. Some aspects of the present invention provide a technique for reducing a communication amount of information for controlling a mobile body.

In view of the above-described issue, a communication apparatus that acquires information used for controlling a mobile body, and includes a specifying unit configured to specify one or more other communication apparatuses with which the communication apparatus is to communicate, based on a geographical location of the mobile body, and an acquisition unit configured to acquire information from the one or more other communication apparatuses that have been specified is provided.

### BRIEF DESCRIPTION OF THE DRAWINGS

FIG. 1 is a block diagram illustrating a configuration example of a vehicle according to an embodiment of the present invention.

FIG. 2 is a block diagram illustrating a configuration example of a remote driving apparatus according to an embodiment of the present invention.

FIG. 3 is a schematic diagram illustrating a console example of remote driving according to an embodiment of the present invention.

FIG. 4 is a schematic diagram illustrating an overview of a communication method according to an embodiment of the present invention.

FIG. 5 is a block diagram illustrating a configuration example of a road management camera according to an embodiment of the present invention.

FIG. 6 is a flowchart illustrating an example of a communication method according to an embodiment of the present invention.

FIG. 7 is a diagram illustrating an example of a camera management table according to an embodiment of the present invention.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

A vehicle 1 includes a vehicle control apparatus 2 (hereinafter, simply referred to as “control apparatus 2”) that controls the vehicle 1. The control apparatus 2 includes a plurality of ECUs 20 to 29 that are communicably connected by an in-vehicle network. Each of the ECUs includes a processor represented by a CPU, a memory such as a semiconductor memory, an interface to an external device, and the like. The memory stores programs that are executed by the processor, data that is used by the processor to perform processing, and the like. Each of the ECUs may include a plurality of processors, memories, interfaces, and the like. For example, the ECU 20 includes a processor 20a and a memory 20b. Processing that is performed by the ECU 20 is executed as a result of the processor 20a executing an instruction included in a program stored in the memory 20b. Alternatively, the ECU 20 may include a dedicated integrated circuit such as an ASIC for executing processing that is performed by the ECU 20. The same applies to the other ECUs.

Functions allocated to the (respective) ECUs 20 to 29, and the like will be described below. Note that the number of ECUs and functions allocated to the ECUs can be designed as appropriate, and can be segmentalized further than those in this embodiment, or can be integrated.

The ECU 20 executes running control related to an automated driving function and a remote driving function of the vehicle 1. In this running control, the ECU 20 automatically controls steering and/or acceleration/deceleration of the vehicle 1. The automated driving function is a function of the ECU 20 planning a running route of the vehicle 1, and controlling steering and/or acceleration/deceleration of the vehicle 1 based on this running route. The remote driving function is a function of the ECU 20 controlling steering and/or acceleration/deceleration of the vehicle 1 in accordance with an instruction from an operator outside the vehicle 1. The operator outside the vehicle 1 may be a human or an AI (artificial intelligence). The ECU 20 can execute the automated driving function and the remote operation function in combination. For example, a configuration may also be adopted in which the ECU 20 plans a running route and performs running control when there is no instruction from an operator, and when there is an instruction from an operator, performs running control in accordance with the instruction.

The ECU 21 controls an electronic power steering apparatus 3. The electronic power steering apparatus 3 includes a mechanism for steering front wheels according to a driver's driving operation (steering operation) on a steering wheel 31. The electronic power steering apparatus 3 also includes a motor that exerts drive force for assisting a steering operation and automatically steering the front wheels, a sensor that detects a steering angle, and the like. When the driving state of the vehicle 1 is an automated driving state, the ECU 21 automatically controls the electronic power steering apparatus 3 according to an instruction from the ECU 20, and controls the direction of forward movement of the vehicle 1.

The ECUs 22 and 23 control detection units 41 to 43 that detect the situation of the outside of the vehicle, and perform information processing on detection results. Each detection unit 41 is a camera for shooting an image ahead of the vehicle 1 (which may hereinafter be referred to as “camera 41”), and, in this embodiment, is installed at a roof front part and on an interior side of the front window. By analyzing an image shot by a camera 41, it is possible to extract the contour of an object and a demarcation line (white line, for example) of a traffic lane on a road.

Each detection unit 42 is a LIDAR (Light Detection and Ranging, may hereinafter be referred to as “LIDAR 42”), detects an object in the surroundings of the vehicle 1, and measures the distance from the object. In this embodiment, five LIDARs 42 are provided, two of the five LIDARs 42 being provided at the respective front corners of the vehicle 1, one at the rear center, and two on the respective sides at the rear. Each detection unit 43 is a millimeter-wave radar (which may hereinafter be referred to as “radar 43”), detects an object in the surroundings of the vehicle 1, and measures the distance from a marker. In this embodiment, five radars 43 are provided, one of the radars 43 being provided at the front center of the vehicle 1, two at the respective front corners, and two at the rear corners.

The ECU 22 controls one camera 41 and the LIDARs 42, and performs information processing on their detection results. The ECU 23 controls the other camera 41 and the radars 43, and performs information processing on their detection results. By providing two sets of apparatuses that detect the surrounding situation of the vehicle, the reliability of detection results can be improved, and by providing detection units of different types such as cameras, LIDARs, and radars, the surrounding environment of the vehicle can be multilaterally analyzed.

The ECU 24 controls a gyro sensor 5, a GPS sensor 24b, and a communication apparatus 24c, and performs information processing on their detection results or communication results. The gyro sensor 5 detects rotary movement of the vehicle 1. A course of the vehicle 1 can be determined based on a detection result of the gyro sensor 5, a wheel speed, and the like. The GPS sensor 24b detects the current position of the vehicle 1. The communication apparatus 24c wirelessly communicates with a server that provides map information and traffic information, and acquires such information. The ECU 24 can access a database 24a of map information built in the memory, and the ECU 24 searches for a route from the current location to a destination, and the like. The ECU 24, the map database 24a, and the GPS sensor 24b constitute a so-called navigation apparatus.

The ECU 25 includes a communication apparatus 25a for inter-vehicle communication. The communication apparatus 25a wirelessly communicates with another vehicle in the surroundings thereof, and exchanges information with the vehicle. The communication apparatus 25a is also used for communication with an operator outside the vehicle 1.

The ECU 26 controls a power plant 6. The power plant 6 is a mechanism for outputting drive force for rotating the drive wheels of the vehicle 1, and includes an engine and a transmission, for example. For example, the ECU 26 controls output of the engine in accordance with a driver's driving operation (an accelerator operation or an accelerating operation) detected by an operation detection sensor 7a provided on an accelerator pedal 7A, and switches the gear stage of the transmission based on information regarding the vehicle speed detected by a vehicle speed sensor 7c. When the driving state of the vehicle 1 is an automated driving state, the ECU 26 automatically controls the power plant 6 in accordance with an instruction from the ECU 20, and controls the acceleration/deceleration of the vehicle 1.

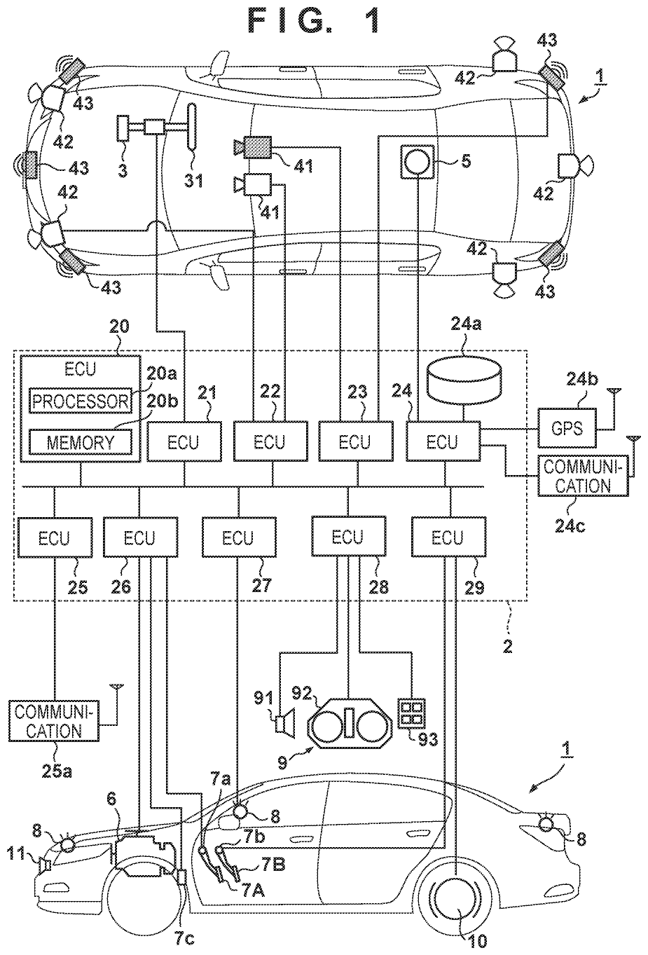

The ECU 27 controls illumination apparatuses 8 (lights such as headlights and taillights) that include direction indicators (blinkers). In the example in FIG. 1, the illumination apparatuses 8 are provided on door mirrors, at the front, and at the rear of the vehicle 1. The ECU 27 further controls an acoustic apparatus 11 that includes a horn and is directed to the outside of the vehicle. The illumination apparatuses 8, the acoustic apparatus 11, or a combination thereof has a function of providing information to the outside the vehicle 1.

The ECU 28 controls an input/output apparatus 9. The input/output apparatus 9 outputs information to the driver, and receives information from the driver. An audio output apparatus 91 notifies the driver of information using sound. A display apparatus 92 notifies the driver of information through image display. The display apparatus 92 is installed in front of the driver's seat, for example, and constitutes an instrument panel, or the like. Note that, here, sound and display are illustrated, but information may be notified using vibration and light. In addition, information may also be notified using a combination of some of sound, display, vibration, and light. Furthermore, the combination or a notification aspect may be different according to the level of information to be notified (for example, an emergency level). Input apparatuses 93 are a group of switches arranged at positions so as to enable the driver to perform an operation on the switches to give an instruction to the vehicle 1, but may include an audio input apparatus. The ECU 28 can give guidance related to running control of the ECU 20. The guidance will be described later in detail. The input apparatuses 93 may also include a switch used for controlling an operation of running control by the ECU 20. The input apparatuses 93 may also include a camera for detecting the direction of a line of sight of the driver.

The ECU 29 controls a brake apparatus 10 and a parking brake (not illustrated). The brake apparatus 10 is, for example, a disk brake apparatus, is provided for each of the wheels of the vehicle 1, and decelerates or stops the vehicle 1 by imposing resistance to rotation of the wheels. The ECU 29 controls activation of the brake apparatus 10, for example, in accordance with a driver's driving operation (brake operation) detected by an operation detection sensor 7b provided on a brake pedal 7B. When the driving state of the vehicle 1 is an automated driving state, the ECU 29 automatically controls the brake apparatus 10 in accordance with an instruction from the ECU 20, and controls deceleration and stop of the vehicle 1. The brake apparatus 10 and the parking brake can also be activated to maintain a stopped state of the vehicle 1. In addition, if the transmission of the power plant 6 includes a parking lock mechanism, this can also be activated in order to maintain a stopped state of the vehicle 1.

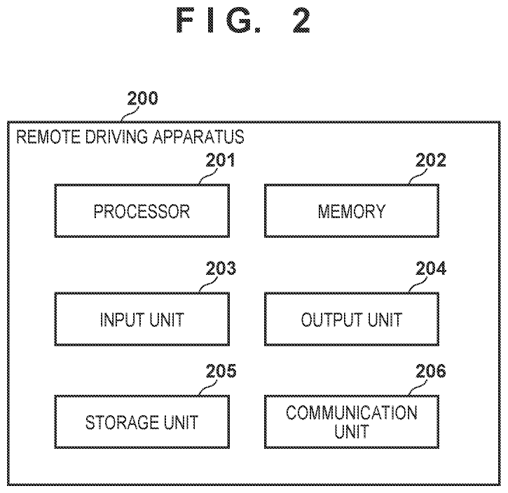

A configuration of a remote driving apparatus 200 according to some embodiments of the present invention will be described with reference to the block diagram in FIG. 2. The remote driving apparatus 200 is an apparatus that provides a remote driving service to a vehicle that has a remote driving function. The remote driving apparatus 200 is positioned at a remote location from a vehicle to which the service is provided.

The remote driving apparatus 200 may be able to provide the remote driving service in a plurality of operation modes. The plurality of operation modes of the remote driving service may include a leading mode and an assisting mode. The leading mode refers to an operation mode in which the operator of the remote driving apparatus 200 specifies control amounts (for example, a steering angle, an accelerator pedal position, a brake pedal position, a position of the directional signal lever, and on/off of the lights) of the vehicle. The assisting mode refers to an operation mode in which the vehicle (specifically, the ECU 20) determines control amounts of the vehicle in accordance with a path plan specified by the operator of the remote driving apparatus 200. In the assisting mode, the operator of the remote driving apparatus 200 may generate and designate a path plan for themselves, or may adopt and designate a path plan suggested by the vehicle.

The remote driving apparatus 200 includes constituent elements shown in FIG. 2. A processor 201 controls overall operations of the remote driving apparatus 200. The processor 201 functions as a CPU, for example. A memory 202 stores programs that are used for operations of the remote driving apparatus 200, temporary data, and the like. The memory 202 is realized by a ROM and a RAM, for example. An input unit 203 is used by the user of the remote driving apparatus 200 to perform input to the remote driving apparatus 200. When a human operates the remote driving apparatus 200, the user of the remote driving apparatus 200 is this human, and when an AI operates the remote driving apparatus 200, the user of the remote driving apparatus 200 is a human (monitoring person) that monitors operations of the AI. An output unit 204 is used for outputting information from the remote driving apparatus 200 to the user. A storage unit 205 stores data used for operations of the remote driving apparatus 200. The storage unit 205 is realized by a storage apparatus such as a disk drive (for example, an HDD or an SSD). A communication unit 206 provides a function of the remote driving apparatus 200 communicating with another apparatus (for example, a vehicle to be remotely driven), and is realized by a network card or an antenna, for example.

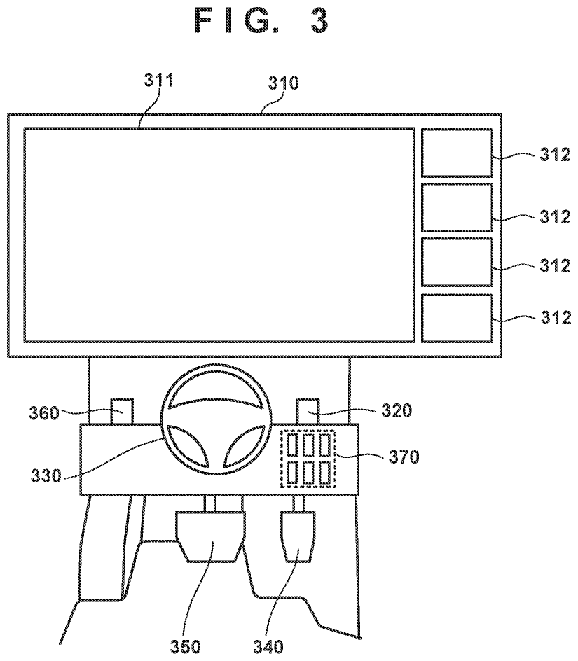

A configuration example of the input unit 203 and the output unit 204 of the remote driving apparatus 200 will be described with reference to the schematic diagram in FIG. 3. In this configuration example, the output unit 204 is constituted by a display apparatus 310 and an acoustic apparatus 320, and the input unit 203 is constituted by a steering wheel 330, an accelerator pedal 340, a brake pedal 350, a microphone 360, and a plurality of switches 370.

The display apparatus 310 is an apparatus that outputs visual information for providing the remote driving service. The acoustic apparatus 320 is an apparatus that outputs audio information for providing the remote driving service. A screen displayed on the display apparatus 310 includes one main region 311 and a plurality of sub regions 312. Information regarding a vehicle to be controlled from among a plurality of vehicles to which the remote driving service is to be provided is displayed in the main region 311. The vehicle to be controlled is a vehicle to which an instruction from the remote driving apparatus 200 is transmitted. Information regarding a vehicle other than the vehicle to be controlled from among the plurality of vehicles to which the remote driving service is provided is displayed in each of the sub regions 312. A vehicle other than the vehicle to be controlled may be called a “vehicle to be monitored”. When one remote driving apparatus 200 provides the remote driving service to a plurality of vehicles, the operator switches a vehicle displayed on the main region 311 (i.e., the vehicle to be controlled) as appropriate. Information displayed on the main region 311 and the sub regions 312 includes the traffic condition in the surrounding of the vehicle, the speed of the vehicle, and the like.

The steering wheel 330 is used for controlling the steering amount of the vehicle to be controlled, in the leading mode. The accelerator pedal 340 is used for controlling the accelerator pedal position of the vehicle to be controlled, in the leading mode. The brake pedal 350 is used for controlling the brake pedal position of the vehicle to be controlled, in the leading mode. The microphone 360 is used for inputting audio information. Audio information input to the microphone 360 is transmitted to the vehicle to be controlled, and is regenerated in the vehicle.

The plurality of switches 370 are used for inputting various types of instructions for providing the remote driving service. For example, the plurality of switches 370 include a switch for switching the vehicle to be controlled, a switch for performing an instruction of a determination result of the operator in the assisting mode, a switch for switching a plurality of operation modes, and the like.

The remote driving apparatus 200 described with reference to FIGS. 2 and 3 can provide both the leading mode and the assisting mode. Alternatively, the remote driving apparatus 200 can provide only one of the leading mode and the assisting mode. When the leading mode is not provided, the steering wheel 330, the accelerator pedal 340, and the brake pedal 350 can be omitted. In addition, the remote driving service may be provided by a plurality of remote driving apparatuses 200 in cooperation. A configuration may be adopted, in this case, a remote driving apparatus 200 can take over a vehicle to which the service is to be provided, from another remote driving apparatus 200.

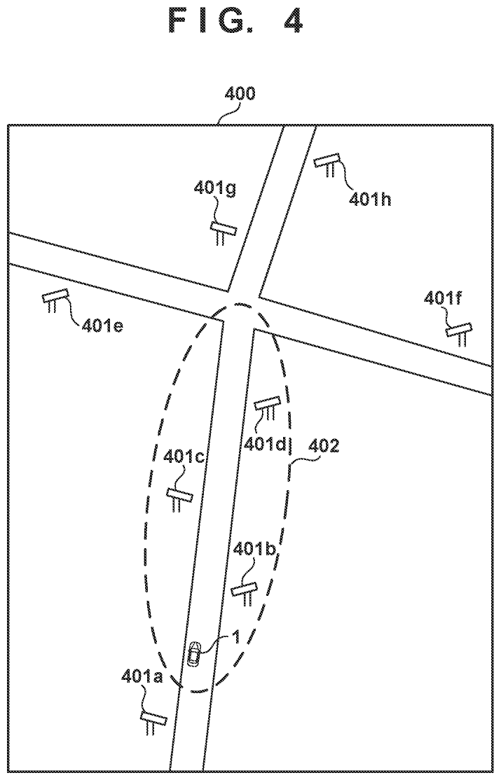

An overview of some embodiments of the present invention will be described with reference to FIG. 4. FIG. 4 shows an environment 400 around the vehicle 1, in the real environment. The vehicle 1 is running on a road. A plurality of road management cameras 401a to 401h are installed along the road. Hereinafter, the road management cameras 401a to 401h are collectively referred to as “road management cameras 401”. Each of the road management cameras 401 shoots an image of a road, generates information regarding the traffic condition based on the shooting result, and transmits this information in accordance with settings made in advance or according to a request from another apparatus (for example, the vehicle 1). A road management camera 401 is an example of a communication apparatus that is used in a fixed state. A road management camera 401 is installed on a traffic light, or installed on a side of a road. Information regarding the traffic condition (hereinafter, referred to as “traffic information”) includes, for example, the geographical locations, speeds, acceleration rates, directions of movement, and the like of traffic participants (vehicles and pedestrians). Traffic information may be an image itself shot by a road management camera 401. Traffic information is an example of information that is used for controlling the vehicle 1.

When the vehicle 1 attempts to acquire traffic information from all of the plurality of road management cameras 401a to 401h, the communication amount increases. In view of this, the vehicle 1 acquires traffic information from some of the plurality of road management cameras 401a to 401h. The vehicle 1 specifies one or more road management cameras for acquiring traffic information, for example, based on the geographical location of the vehicle 1. For example, the control apparatus 2 acquires traffic information from the road management cameras 401b to 401d included in an area 402 that is defined based on the geographical location of the vehicle 1 in the environment 400. A method for specifying one or more road management cameras for acquiring traffic information will be described later in detail.

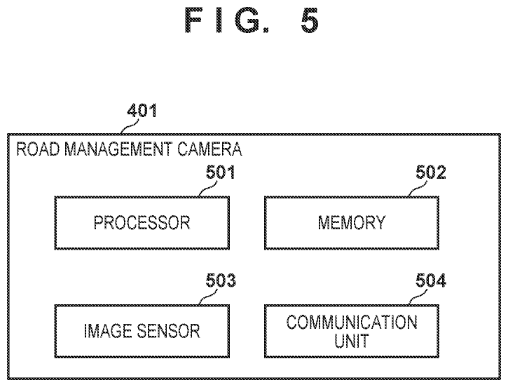

A configuration of a road management camera 401 according to some embodiments of the present invention will be described with reference to the block diagram in FIG. 5. The road management camera 401 includes the constituent elements shown in FIG. 5. A processor 501 controls overall operations of the road management camera 401. The processor 501 functions as a CPU, for example. A memory 502 stores programs used for operations of the road management camera 401, temporary data, and the like. The memory 502 is realized by a ROM, a RAM, and the like. An image sensor 503 is a sensor for generating an image of a road. A communication unit 504 provides a function that allows the road management camera 401 to communicate with another apparatus (for example, an information management server or a vehicle), and is realized by a network card, an antenna, and the like. The communication unit 504 may include both an interface for cellular network communication and an interface for peer-to-peer communication. The processor 501 generates traffic information based on an image of the road obtained by the image sensor 503, and transmits this traffic information to another apparatus using the communication unit 504.

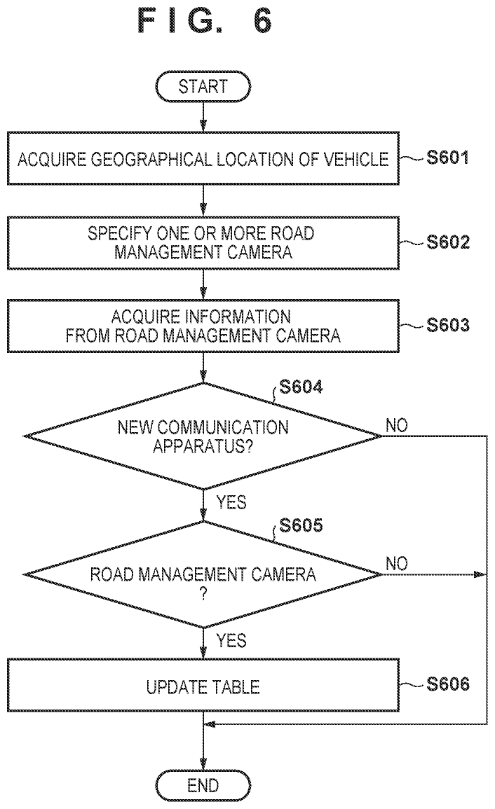

An example of a communication method for acquiring traffic information from one or more road management cameras will be described with reference to FIG. 6. This method may be performed as a result of a processor (for example, the processor 20a) of the control apparatus 2 of the vehicle 1 executing a program stored in a memory (for example, the memory 20b). Alternatively, some or all of the processes of the method may be executed by a dedicated circuit such as an ASIC (application specific integrated circuit). In the former case, the processor serves as a constituent element for a specific operation, and, in the latter case, the dedicated circuit serves as a constituent element for a specific operation. The method in FIG. 6 is repeatedly executed while the vehicle 1 is running, for example. The control apparatus 2 that executes the communication method functions as a communication apparatus. In addition, a road management camera 401 that transmits traffic information to the control apparatus 2 also functions as a communication apparatus.

In step S601, the control apparatus 2 acquires the current geographical location of the vehicle 1. The geographical location is acquired using the GPS sensor 24b, for example. In step S602, the control apparatus 2 specifies one or more road management cameras 401 with which the control apparatus 2 is to communicate from among a plurality of candidate road management cameras 401, based on the geographical location of the vehicle 1. In step S603, the control apparatus 2 acquires traffic information by receiving it from the one or more road management cameras 401 that have been specified. A configuration may be adopted in which, if the one or more road management cameras 401 that have been specified comply with wireless communication, the control apparatus 2 establishes wireless communication with these road management cameras 401, and receives traffic information through this wireless communication. The control apparatus 2 does not need to acquire traffic information from road management cameras 401 other than the one or more road management cameras 401 that have been specified, from among a plurality of candidate road management cameras 401. For example, there are cases where a road management camera 401 specialized for generating a control instruction that is frequently required by a vehicle is placed at an intersection. In this case, the control apparatus 2 does not need to acquire traffic information from road management cameras 401 other than the specialized road management camera 401.

Various techniques for specifying one or more road management cameras 401 in step S602 are described as follows. These techniques may be used independently or in combination.

The control apparatus 2 may also specify one or more road management cameras 401 by referencing a camera management table 700 in which information regarding a plurality of road management cameras 401 is recorded. The plurality of road management cameras 401 recorded in the camera management table 700 are the plurality of candidate road management cameras 401 in step S602. The camera management table 700 may be stored in the control apparatus 2, or may be stored in an apparatus other than the control apparatus 2 (outside the vehicle 1). If the management table 700 is stored in an external apparatus, the control apparatus 2 inquires of this apparatus as to recorded content of the management table 700.

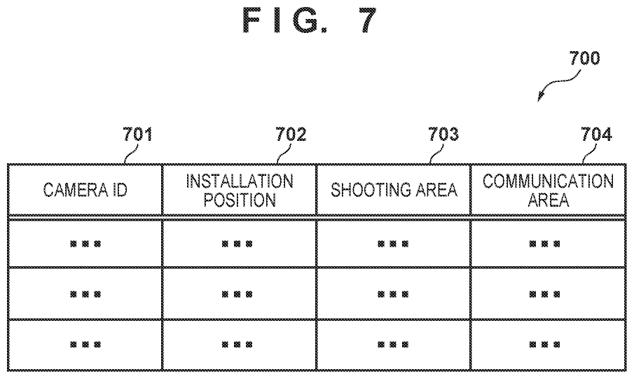

A specific example of the camera management table 700 will be described with reference to FIG. 7. A column 701 (“camera ID”) represents identification information for uniquely identifying the road management cameras 401. This identification information may also be used as addresses for communication. Alternatively, communication addresses may be managed separately. A column 702 (“installation position”) represents geographical locations in which the road management cameras 401 are installed. A column 703 (“shooting area”) represents shootable ranges of geographical locations of the road management cameras 401. A column 704 (“communication area”) represents directly communicable ranges of geographical locations of the road management cameras 401. The control apparatus 2 can determine one or more road management cameras 401 with which the control apparatus 2 is to communicate, for each geographical location of the vehicle 1 by referencing the camera management table 700.

A configuration may also be adopted in which the control apparatus 2 references the camera management table 700, and specifies one or more road management cameras 401 whose communication areas indicated in the column 704 include the geographical location of the vehicle 1, from among the plurality of road management cameras 401 managed in the camera management table 700. The control apparatus 2 can acquire traffic information from the one or more road management cameras 401 that have been specified in this manner, through direct communication (peer-to-peer communication). Accordingly, the control apparatus 2 can reduce the amount of communication with a cellular network.

The control apparatus 2 may also specify one or more road management cameras 401 based further on the speed and/or direction of movement of the vehicle 1. For example, the control apparatus 2 may also specify one or more road management cameras 401 positioned along the direction of forward movement, based on the direction of movement of the vehicle 1. A configuration may also be adopted in which the control apparatus 2 calculates a range of location that is reached from the current geographical location in a predetermined time (for example, 5 minutes) based on the speed of the vehicle 1, and specifies one or more road management cameras 401 for shooting images in this range.

The control apparatus 2 may also specify one or more road management cameras 401 based further on the operation mode of the vehicle 1. When the vehicle 1 is in an automated driving mode or a remote driving mode, the control apparatus 2 may use traffic information from a larger number of road management cameras 401 compared with a manual driving mode, in order to increase the safety. Accordingly, the control apparatus 2 may also specify one or more road management cameras 401 such that the number of road management cameras 401 that are specified when the vehicle 1 is in the manual driving mode is smaller than the number of road management cameras 401 that are specified when the vehicle 1 is in the automated driving mode or the remote driving mode. For example, the control apparatus 2 may also specify, when the operation mode is the manual driving mode, one or more road management cameras 401 that are closer to the current position of the vehicle 1, from among road management cameras 401 that are specified when the operation mode is the automated driving mode or the remote driving mode.

The control apparatus 2 may also specify one or more road management cameras 401, based on the type of the geographical location of the vehicle 1. For example, when the vehicle is in a vicinity of an intersection, the control apparatus 2 may specify a road management camera 401 installed on a traffic light of this intersection, and acquire traffic information from this road management camera 401.

In step S604, the control apparatus 2 determines whether or not a new communication apparatus that can communicate with the control apparatus 2 has been discovered. If a new communication apparatus has been discovered (“YES” in step S604), the control apparatus 2 advances the procedure to step S605, and otherwise the control apparatus 2 ends the procedure. A new communication apparatus is an apparatus that is not registered (i.e. not recorded) in the camera management table 700. The control apparatus 2 may discover a new communication apparatus, for example, by receiving a broadcast signal transmitted from the communication apparatus.

In step S605, the control apparatus 2 determines whether or not the discovered communication apparatus is a road management camera. If the discovered communication apparatus is a road management camera (“YES” in step S605), the control apparatus 2 advances the procedure to step S606, and otherwise the control apparatus 2 ends the procedure. The control apparatus 2 may inquire the discovered communication apparatus or analyze the received broadcast signal in order to determine whether or not the discovered communication apparatus is a road management camera.

In step S606, the control apparatus 2 registers information regarding the discovered road management camera in the camera management table 700. The control apparatus 2 may acquire information regarding the road management camera from this road management camera. Accordingly, if the type of the newly discovered communication apparatus is the same as the type of a communication apparatus (a road management camera 401) recorded in the camera management table 700, the control apparatus 2 updates the camera management table 700. If the management table 700 is stored in an external apparatus, the control apparatus 2 may request this apparatus to update the management table 700. The external apparatus may also update the management table 700 independently.

In the communication method shown in FIG. 6, the control apparatus 2 of the vehicle 1 (for example, the ECU 20 mounted in the vehicle 1) specifies one or more road management cameras 401 for acquiring traffic information, and acquires traffic information from these cameras. Alternatively, an external communication apparatus (for example, the remote driving apparatus 200) distant from the vehicle 1 may also execute these operations. For example, a communication apparatus for acquiring information that is used for controlling a mobile body (the vehicle 1) may be the remote driving apparatus 200 distant from the vehicle 1. In this case, the remote driving apparatus 200 specifies one or more other communication apparatuses (for example, a shoulder apparatus) with which the remote driving apparatus 200 is to communicate, based on the geographical location of the vehicle 1 to which remote driving service is provided. In step S601, an external communication apparatus (for example, the remote driving apparatus 200) acquires a geographical location of a mobile body by receiving the current geographical location of the vehicle 1 from the vehicle 1.

In place of the control apparatus 2 or an external communication apparatus acquiring traffic information that is used for controlling a vehicle, the communication apparatus or an external communication apparatus may execute the method in FIG. 6 to acquire information that is used for controlling a mobile body that is not a vehicle.

Overview of Embodiments

### Configuration 1

A communication apparatus (2, 200) that acquires information used for controlling a mobile body (1), the apparatus comprising:

a specifying unit configured to specify one or more other communication apparatuses (401b to 401d) with which the communication apparatus is to communicate, based on a geographical location of the mobile body (step S602); and

an acquisition unit configured to acquire information from the one or more other communication apparatuses that have been specified (step S603).

According to this configuration, it is possible to reduce the communication amount of information used for controlling a mobile body.

### Configuration 2

The communication apparatus according to configuration 1,

wherein the one or more other communication apparatuses include a communication apparatus that is used in a fixed state.

According to this configuration, it is possible to acquire information at a fixed position.

### Configuration 3

The communication apparatus according to configuration 1 or 2, further comprising:

a communication control unit configured to establish wireless communication with the one or more other communication apparatuses that have been specified.

According to this configuration, information can be acquired through wireless communication.

### Configuration 4

The communication apparatus according to any one of configurations 1 to 3,

wherein the specifying unit specifies the one or more other communication apparatuses, based on a record of a recording unit (700) which is configured to determine, for each geographical location of the mobile body, the one or more other communication apparatuses with which the communication apparatus is to communicate.

According to this configuration, one or more communication apparatuses can be specified based on a record.

### Configuration 5

The communication apparatus according to configuration 4,

wherein the record is updated when a communication apparatus that is communicable, and is other than the communication apparatuses recorded in the recording unit is discovered (step S604).

According to this configuration, candidate communication apparatuses can be extended.

### Configuration 6

The communication apparatus according to configuration 5,

wherein the record is updated when a type of the communication apparatus that is not recorded is the same as a type of a communication apparatus recorded in the recording unit (step S605).

According to this configuration, candidate communication apparatuses can be extended.

### Configuration 7

The communication apparatus according to any one of configurations 1 to 6,

wherein, when the mobile body is at a predetermined geographical location, the acquisition unit does not acquire information from communication apparatuses (401a, 401e to 401h) other than the one or more other communication apparatuses that have been specified.

According to this configuration, the communication amount can be more reduced.

### Configuration 8

The communication apparatus according to any one of configurations 1 to 7,

wherein the specifying unit specifies the one or more other communication apparatuses based further on an operation mode of the mobile body.

According to this configuration, one or more communication apparatuses can be more appropriately specified based on the operation mode of a mobile body.

Configuration 9

The communication apparatus according to any one of configurations 1 to 8,

wherein the specifying unit specifies the one or more other communication apparatuses based on a type of a geographical location of the mobile body.

According to this configuration, one or more communication apparatuses can be more appropriately specified based on the type of the geographical location of a mobile body.

### Configuration 10

The communication apparatus according to any one of configurations 1 to 9,

wherein the specifying unit specifies the one or more other communication apparatuses based further on at least one of a speed of the mobile body and/or a direction of movement of the mobile body.

According to this configuration, one or more communication apparatuses can be more appropriately specified based on a speed and/or a direction of movement of a mobile body.

### Configuration 11

The communication apparatus according to any one of configurations 1 to 10,

wherein the mobile body is a vehicle (1), and

the number of one or more other communication apparatuses that are specified by the specifying unit when the mobile body is in a manual driving mode is smaller than the number of one or more other communication apparatuses that are specified by the specifying unit when the mobile body is in an automated driving mode or a remote driving mode.

According to this configuration, one or more communication apparatuses can be more appropriately specified based on the operation mode of a mobile body.

### Configuration 12

The communication apparatus according to any one of configurations 1 to 11,

wherein the communication apparatus is an ECU mounted in the mobile body.

According to this configuration, the communication amount of a mobile body can be reduced.

### Configuration 13

The communication apparatus according to configuration 12,

wherein the acquisition unit acquires information through direct communication with the one or more other communication apparatuses that have been specified.

According to this configuration, the communication amount of a cellular network cellular network can be reduced.

### Configuration 14

The communication apparatus according to any one of configurations 1 to 11,

wherein the communication apparatus is a remote driving apparatus that is distant from the mobile body.

According to this configuration, it is possible to reduce the communication amount of a communication apparatus that remotely controls a mobile body.

### Configuration 15

The communication apparatus according to any one of configurations 1 to 14,

wherein the mobile body is a vehicle (1), and the one or more other communication apparatuses are related to a camera (401) that shoots an image of a road.

According to this configuration, it is possible to reduce a communication amount of traffic information used for controlling a vehicle.

### Configuration 16

A non-transitory storage medium that stores a program for causing a computer to function as each unit of the control apparatus according to any one of configurations 1 to 15.

According to this configuration, the above configuration can be realized in a form of a storage medium that stores a program.

### Configuration 17

A communication method for a communication apparatus acquiring information used for controlling a mobile body (1), the method comprising:

specifying one or more other communication apparatuses (401b to 401d) with which the communication apparatus is to communicate, based on a geographical location of the mobile body (step S602); and

acquiring information from the one or more other communication apparatuses that have been specified (step S603).

According to this configuration, it is possible to reduce the communication amount of information used for controlling a mobile body.

The invention is not limited to the foregoing embodiments, and various variations/changes are possible within the spirit of the invention.

What is claimed is:

1. A communication apparatus that acquires information used for controlling a mobile body, the apparatus comprising:
a specifying unit configured to specify one or more other communication apparatuses with which the communication apparatus is to communicate, based on a geographical location of the mobile body; and
an acquisition unit configured to acquire information from the one or more other communication apparatuses that have been specified.

2. The communication apparatus according to claim 1,
wherein the one or more other communication apparatuses include a communication apparatus that is used in a fixed state.

3. The communication apparatus according to claim 1, further comprising:
a communication control unit configured to establish wireless communication with the one or more other communication apparatuses that have been specified.

4. The communication apparatus according to claim 1,
wherein the specifying unit specifies the one or more other communication apparatuses, based on a record of a recording unit which is configured to determine, for each geographical location of the mobile body, the one or more other communication apparatuses with which the communication apparatus is to communicate.

5. The communication apparatus according to claim 4,
wherein the record is updated when a communication apparatus that is communicable, and is other than the communication apparatuses recorded in the recording unit is discovered.

6. The communication apparatus according to claim 5,
wherein the record is updated when a type of the communication apparatus that is not recorded is the same as a type of a communication apparatus recorded in the recording unit.

7. The communication apparatus according to claim 1,
wherein, when the mobile body is at a predetermined geographical location, the acquisition unit does not acquire information from communication apparatuses other than the one or more other communication apparatuses that have been specified.

8. The communication apparatus according to claim 1,
wherein the specifying unit specifies the one or more other communication apparatuses based further on an operation mode of the mobile body.

9. The communication apparatus according to claim 1,
wherein the specifying unit specifies the one or more other communication apparatuses based on a type of a geographical location of the mobile body.

10. The communication apparatus according to claim 1,
wherein the specifying unit specifies the one or more other communication apparatuses based further on at least one of a speed of the mobile body and/or a direction of movement of the mobile body.

11. The communication apparatus according to claim 1,
wherein the mobile body is a vehicle, and
the number of one or more other communication apparatuses that are specified by the specifying unit when the mobile body is in a manual driving mode is smaller than the number of one or more other communication apparatuses that are specified by the specifying unit when the mobile body is in an automated driving mode or a remote driving mode.

12. The communication apparatus according to claim 1,
wherein the communication apparatus is an ECU mounted in the mobile body.

13. The communication apparatus according to claim 12,
wherein the acquisition unit acquires information through direct communication with the one or more other communication apparatuses that have been specified.

14. The communication apparatus according to claim 1,
wherein the communication apparatus is a remote driving apparatus that is distant from the mobile body.

15. The communication apparatus according to claim 1,
wherein the mobile body is a vehicle, and
the one or more other communication apparatuses are related to a camera that shoots an image of a road.

16. A non-transitory storage medium that stores a program for causing a computer to function as each unit of the communication apparatus according to claim 1.

17. A communication method for a communication apparatus acquiring information used for controlling a mobile body, the method comprising:
specifying one or more other communication apparatuses with which the communication apparatus is to communicate, based on a geographical location of the mobile body; and
acquiring information from the one or more other communication apparatuses that have been specified.
